(19) United States
(12) Patent Application Publication
(10) Pub. No.: US 2008/0013863 A1
(43) Pub. Date: Jan. 17, 2008

(54) Apparatus, method, and medium for retrieving photo based on spatial information

(75) Inventors: Yong Lee, Yongin-si (KR); Yong Ju Jung, Daejeon (KR); Ji Yeun Kim, Seoul (KR); Sang Kyun Kim, Yongin-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/598,099

(22) Filed: Nov. 13, 2006

(30) Foreign Application Priority Data
Jul. 11, 2006 (KR) 10-2006-0064751

(51) Int. Cl. G06K 9/46; G06K 9/54; G06K 9/66; G06K 9/60

(52) U.S. Cl. 382/305; 382/190

(57) ABSTRACT

An apparatus, a method, and a medium for retrieving a photo based on spatial information. The apparatus for retrieving a photo includes: a spatial information extractor to extract spatial information and a photo from photo data; a map range mapper to map the extracted spatial information and a map range corresponding to the spatial information; a spatial range query processor to process a spatial range query; a spatial indexer to perform spatial indexing of mapping information; and a retrieval result output unit to retrieve the photo associated with the spatial range query through the spatial indexing, and to output the retrieved photo to a display unit to display the retrieved photo.

### CROSS-REFERENCE TO RELATED APPLICATIONS

This application claims the benefit of Korean Patent Application No. 10-2006-0064751, filed on Jul. 11, 2006, in the Korean Intellectual Property Office, the disclosure of which is incorporated herein by reference.

### BACKGROUND OF THE INVENTION

1. Field of the Invention

The present invention relates to an apparatus, a method, and a medium for retrieving a photo based on spatial information, and more particularly, to an apparatus, a method, and medium for retrieving a photo based on spatial information, which map spatial information and a map range corresponding to the spatial information, perform spatial indexing of mapping information, and thereby may retrieve the photo.

2. Description of the Related Art

Currently, people take many photographs, because digital cameras have become popular. Accordingly, technology for arranging photos and retrieving a particular photo is highly desired, because people desire to collect, arrange, and retrieve many photos. Various methods, which automatically arrange photos and retrieve a particular photo based on a photographed location, a photographed time, and an image content of the photo, have been proposed.

The photographed location and the photographed time may be used as a basic retrieval key. However, in order to add information about the photographed location to each photo image, the user is required to designate the information about the photographed location for each photo image, which causes great inconvenience to a user.

To overcome the disadvantage described above, methods of indexing a photo image and information about latitude and longitude have been proposed. In this instance, the information about latitude and longitude is obtained from a global positioning system (GPS) and other radio-frequency based on location estimation technologies.

The methods of using spatial information by the GPS may overcome a disadvantage of arranging photos. Particularly, when photographed, the photographed time and the photographed location are simultaneously stored, and the information about latitude and longitude and information about the photo are mapped and indexed. Accordingly, a particular photo may be retrieved through a user interface. However, in existing methods, the photo is mapped as a point on a map. Accordingly, it may be limited to a simple system of retrieving a photo by selecting a particular location on the map. Also, as shown in FIG. 1, a location of a subject may not be identical to spatial information of a photo. In this instance, the spatial information is obtained by the GPS.

As an example, referring to FIG. 1, a subject ‘P’ is photographed at a source location ‘O’. In this specification, the source location refers to a location from where a photo is taken. When an indexing is performed using only information about the source location ‘O’, and the subject ‘P’ is desired to be retrieved, the subject ‘P’ may not be retrieved, since a location of the subject ‘P’ and the photographed location are different. Also, when the indexing is performed by using the subject ‘P’, an error on the indexing may occur. For example, when another object between the subject ‘P’ and the source location ‘O’ is photographed, the error may occur.

As described above, when the location of the subject is not identical to the spatial information of the photo by the GPS, the indexing may not be accurate. Accordingly, a two/three dimensional spatial indexing is required to represent the geographic space of the photo taken as well as one dimensional point indexing. Particularly, in order to estimate the geographic area for each photo exactly as possible, information about a location, a direction, a distance between the photographed location and a subject, tilt angle information, and pan angle information is required to be considered.

### SUMMARY OF THE INVENTION

An aspect of the present invention provides an apparatus, a method, and a medium for retrieving a photo based on spatial information, in which a spatial indexing is performed by using spatial information of a photo which is taken, and thereby an accurate photo retrieval may be performed.

An aspect of the present invention also provides an apparatus, a method, and medium for retrieving a photo based on spatial information, which map spatial information of a photo and a map range, perform spatial indexing of mapping information, and retrieve the photo of a spatial range query.

An aspect of the present invention also provides an apparatus, a method, and medium for retrieving a photo based on spatial information, which quickly retrieve a photo of a spatial range query, through a spatial indexing.

An aspect of the present invention also provides an apparatus, a method, and a medium for retrieving a photo based on spatial information, which effectively perform a spatial range retrieval due to a fast photo retrieval, through a spatial indexing.

According to an aspect of the present invention, there is provided an apparatus for retrieving a photo, including: a spatial information extractor to extract spatial information and a photo from photo data; a map range mapper to map the extracted spatial information and a map range corresponding to the spatial information; a spatial range query processor to process a spatial range query; a spatial index to perform spatial indexing of mapping information; and a retrieval result output unit to retrieve the photo associated with the spatial range query through the spatial indexing, and to output the retrieved photo.

In an aspect of the present invention, the spatial information extractor extracts at least one of location information, direction information, information about a distance between a subject and a source location, pan angle information, and tilt angle information.

In an aspect of the present invention, an apparatus for retrieving a photo includes a spatial range query determiner to classify a query into the spatial range query and a non-spatial range query.

In an aspect of the present invention, an apparatus for retrieving a photo includes a photo database where the photo extracted by the spatial information extractor is stored, a map database where map information is stored, and a mapping database where the extracted spatial information and the mapping information of the map range corresponding to the spatial information is stored.

In an aspect of the present invention, the spatial range indexer indexes the mapping information based on a rectangle tree (R-Tree) method.

In an aspect of the present invention, the spatial range indexer indexes the mapping information based on a k-dimensional tree (K-D Tree) method.

In an aspect of the present invention, the spatial range query processor processes a spatial range query corresponding to any one of a square, a cube, a circle, a sphere, and a free-shape which is generated by connecting locations designated by a user.

In an aspect of the present invention, an apparatus for retrieving a photo includes a photo data generator to generate the photo data, a query generator to generate the spatial range query, and a display to display the retrieved photo.

According to another aspect of the present invention, there is provided a method of retrieving a photo, including: extracting spatial information and a photo from photo data; mapping the extracted spatial information and a map range corresponding to the spatial information; storing the extracted photo and mapping information; performing spatial indexing of the mapping information; and retrieving the photo associated with a spatial range query through the spatial indexing.

In an aspect of the present invention, the extracted spatial information includes at least one of location information, direction information, information about a distance between a subject and a source location, pan angle information, and tilt angle information.

In an aspect of the present invention, a method of retrieving a photo includes classifying a query into the spatial range query and a non-range query, and the photo associated with the spatial range query is retrieved through the spatial indexing, when the query is the spatial range query

In an aspect of the present invention, a method of retrieving a photo includes displaying a spatial range and the retrieved photo.

In an aspect of the present invention, the performing spatial indexing may index the mapping information based on an R-Tree method.

In an aspect of the present invention, the performing spatial indexing may index the mapping information based on a K-D Tree method.

According to another aspect of the present invention, there is provided at least one computer readable medium storing instructions that control at least one processor to implement a method of retrieving a photo, the method including: extracting spatial information and a photo from photo data; mapping the extracted spatial information and a map range corresponding to the spatial information; storing the extracted photo and mapping information; performing spatial indexing of the mapping information; and retrieving the photo associated with a spatial range query through the spatial indexing.

In an aspect of the present invention pertaining to at least one computer readable medium, the method may further include displaying the retrieved photo.

According to another aspect of the present invention, there is provided an apparatus for retrieving a photo, including a spatial information extractor to extract spatial information and a photo from photo data; a map range mapper to map the extracted spatial information and to map a map range corresponding to the spatial information; a spatial range query processor to process a spatial range query; a spatial indexer to perform spatial indexing of mapping information; and a spatial range query determiner to classify a query into the spatial range query and a non-spatial range query and to output the photo associated with the spatial range query through the spatial indexing.

In an aspect of the present invention, the spatial information extractor extracts at least one of location information, direction information, information about a distance between a subject and a source location, pan angle information, and tilt angle information.

In an aspect of the present invention, the spatial indexer indexes the mapping information based on a rectangle tree (R-Tree) method.

In an aspect of the present invention, the spatial indexer indexes the mapping information based on a k-dimensional tree (K-D Tree) method.

In an aspect of the present invention, the spatial range query processor processes a spatial range query corresponding to any one of a square, a cube, a circle, a sphere, and a free-shape which is generated by connecting locations designated by a user.

In an aspect of the present invention, the apparatus may further include a photo data generator to generate the photo data; a query generator to generate the spatial range query; and a display to display the retrieved photo output from the spatial range query determiner.

According to another aspect of the present invention, there is provided a method of retrieving a photo, including: extracting spatial information and a photo from photo data; searching a mapping database for a map range corresponding to the extracted spatial information; mapping the extracted spatial information and the map range corresponding to the spatial information; storing the extracted photo and mapping information; performing spatial indexing of the mapping information; and retrieving the photo associated with a spatial range query through the spatial indexing.

According to another aspect of the present invention, there is provided at least one computer readable medium storing instructions that control at least one processor to implement a method of retrieving a photo, the method including: extracting spatial information and a photo from photo data; searching a mapping database for a map range corresponding to the extracted spatial information; mapping the extracted spatial information and the map range corresponding to the spatial information; storing the extracted photo and mapping information; performing spatial indexing of the mapping information; and retrieving the photo associated with a spatial range query through the spatial indexing.

Additional and/or other aspects, features, and advantages of the present invention will be set forth in part in the description which follows and, in part, will be obvious from the description, or may be learned by practice of the invention.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

These and/or other aspects, features, and advantages of the invention will become apparent and more readily appreciated from the following description of exemplary embodiments, taken in conjunction with the accompanying drawings of which:

FIG. 1 is a diagram illustrating an example of a failure in retrieving a photo in a conventional point indexing according to a conventional art;

FIG. 2 is a block diagram illustrating an apparatus for retrieving a photo based on spatial information according to an exemplary embodiment of the present invention;

FIG. 3 is a diagram illustrating an example of mapping configuration based on spatial information of a photo according to an exemplary embodiment of the present invention;

FIG. 4 is a diagram illustrating an example in which a map range mapping unit illustrated in FIG. 2 maps spatial information on a three dimensional spatial range;

FIG. 5 is a diagram illustrating an example of a minimum bounding cube of each photographed range by spatial indexing according to an exemplary embodiment of the present invention;

FIG. 6 is a diagram illustrating an example of a spatial range query, as a dotted line, according to an exemplary embodiment of the present invention;

FIG. 7 is a diagram illustrating an example of three dimensional spatial indexing which is performed based on a minimum bounding cube according to an exemplary embodiment of the present invention;

FIG. 8 is a diagram illustrating a retrieval process of an R-Tree method with respect to a spatial range query of FIG. 6;

FIG. 9 is a diagram illustrating an example of a two dimensional range query and a retrieval result of the two dimensional range query according to an exemplary embodiment of the present invention; and

FIG. 10 is a flowchart illustrating a method of retrieving a photo based on spatial information according to an exemplary embodiment of the present invention.

### DETAILED DESCRIPTION OF THE PREFERRED EMBODIMENTS

Reference will now be made in detail to exemplary embodiments of the present invention, examples of which are illustrated in the accompanying drawings, wherein like reference numerals refer to the like elements throughout. Exemplary embodiments are described below in order to explain the present invention by referring to the figures.

Exemplary embodiments provide a method, apparatus, and medium for retrieving a photo based on spatial information to effectively retrieve a photo through a two/three dimensional spatial instead of one dimensional point indexing. An apparatus, a method, and a medium of retrieving a photo based on spatial information to map spatial information included in a photo data and to map a map range corresponding to the spatial information, perform spatial indexing of mapping information, and retrieve the photo of a spatial range query.

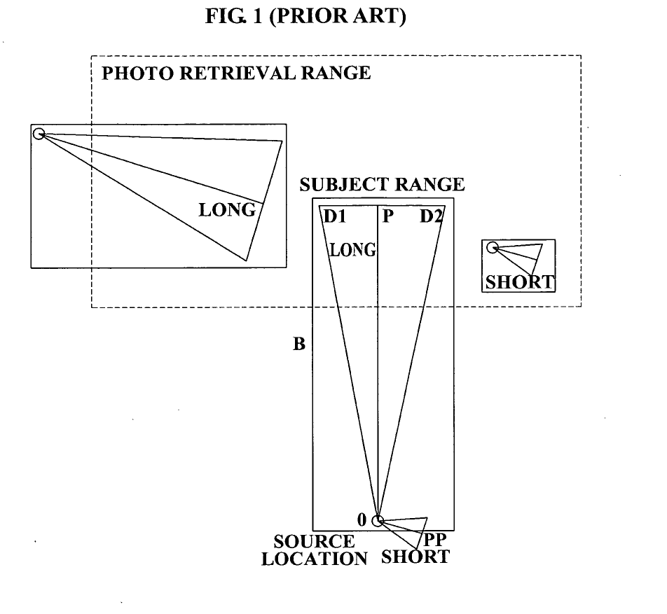

For example, an apparatus for and a method of retrieving a photo based on spatial information performs spatial indexing a range ‘B’ shown in FIG. 1. In this example, the range ‘B’ corresponds to a space between a subject ‘P’ and a source location ‘O’. More particularly, a spatial indexing of a sector is performed. In this example, the sector is a slice connecting the source location ‘O’, a subject range ‘D1’, and another subject range ‘D2’. When the subject ‘P’ is an object to be photographed, a distance between the source location ‘O’ and the subject ‘P’ may be shortened due to another object between the source location ‘O’ and the subject ‘P’. However, in this specification, only cases without an interruption described as above may be considered. Although the interruption described above may exist, the distance between the source location ‘O’ and the subject ‘P’ may be modified, and spatial indexing according to an exemplary embodiment of the present invention may be performed. Also, when a distance is short like a distance between the source location ‘O’ and a ‘PP’ shown in FIG. 1, the short distance may be ignored, and can be considered as a location point.

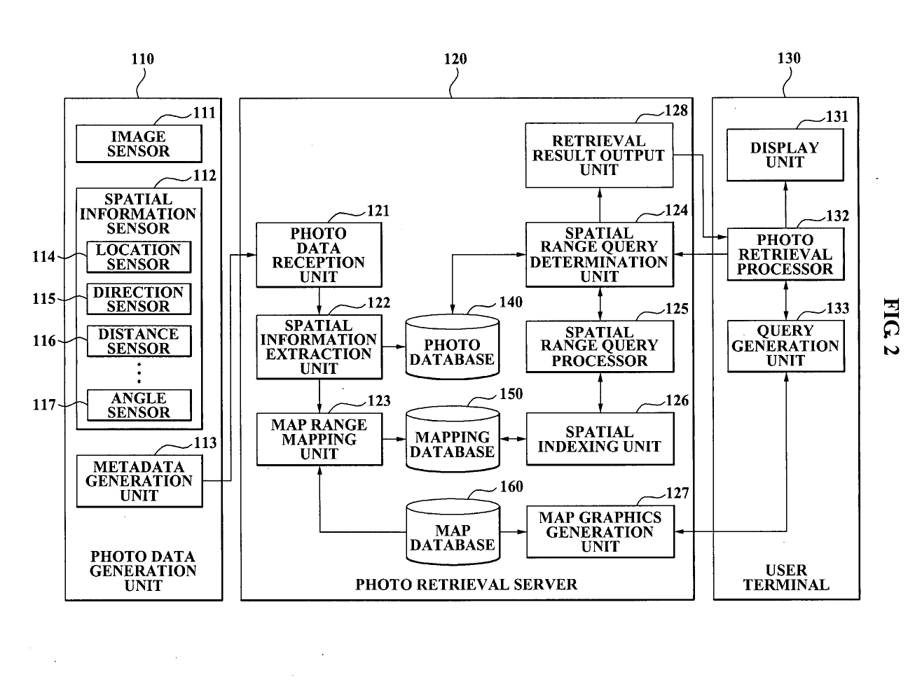

FIG. 2 is a block diagram illustrating an apparatus for retrieving a photo based on spatial information according to an exemplary embodiment of the present invention.

Referring to FIG. 2, an apparatus for retrieving a photo based on spatial information according to an exemplary embodiment of the present invention includes a photo data generation unit (photo data generator) 110, a photo retrieval server 120, and a user terminal 130. In this example, an apparatus for retrieving a photo based on spatial information according to an exemplary embodiment of the present invention may have a configuration including the photo retrieval server 120, or the photo data generation unit 110 and the photo retrieval server 120, or the photo retrieval server 120 and the user terminal 130, or the photo data generation unit 110, the photo retrieval server 120, and the user terminal 130. Specifically, an apparatus for retrieving a photo based on spatial information basically includes the photo retrieval server 120, and additionally may include the photo data generation unit 110 or the user terminal 130.

The photo data generation unit 110 generates a photo and spatial information about the photo. The photo data generation unit 110 includes an image sensor 111 generating the photo, a spatial information sensor 112 generating the spatial information, and a metadata generation unit (metadata generator) 113 generating metadata or photo data which includes a photo image and the spatial information. Specifically, the photo data generation unit 110 takes the photo, computes the spatial information of the photo which is taken, and generates the metadata including the photo image and the spatial information of the photo. For example, the photo data generation unit 110 may be a digital camera.

The spatial information sensor 112 may include a location sensor 114 estimating a source location, a direction sensor 115 estimating a source direction, a distance sensor 116 estimating a distance between a subject and a source location, and an angle sensor 117 estimating an angle. In exemplary embodiments, the source location refers to the location from where the photo is taken, and the source direction refers to a direction from a source location towards a subject when the photo is taken. Also, the spatial information may include source location information, source direction information, information about a distance between the subject and the source location, pan angle information, and tilt angle information. When different spatial information is needed, another sensor for estimating the different spatial information may be added.

The photo retrieval server 120 includes a photo data reception unit (photo data receiver) 121, a spatial information extraction unit (spatial information extractor) 122, a map range mapping unit (map range mapper) 123, a spatial range query determination unit (spatial range query determiner) 124, a spatial range query processor 125, a spatial indexing unit (spatial indexer) 126, a map graphics generation unit (map graphics generator) 127, a retrieval result output unit 128, a photo database 140, a mapping database 150, and a map database 160.

The photo data reception unit 121 receives photo data which is generated in the photo data generation unit 110. Specifically, the photo data reception unit 121 receives the photo image which is taken in the photo data generation unit 110, and the spatial information of the photo.

The spatial information extraction unit 122 extracts the photo and the spatial information by parsing the photo data. In exemplary embodiments, the extracted photo may be stored in the photo database. Also, the extracted spatial information may be at least one of the source location information, the source direction information, the information about the distance between the subject and the source location, the pan angle information, and the tilt angle information, of the extracted photo.

The map range mapping unit 123 searches the map database for a map range corresponding to the spatial information which is extracted from the spatial information extraction unit 122. Also, the map range mapping unit 123 maps the map range and the extracted spatial information, and stores mapping information in the mapping database. In exemplary embodiments, the mapping information refers to information in which the map range and the extracted spatial information are mapped. Specifically, the map range mapping unit 123 maps the spatial information of the photo and the map range of a precise location of the photo, and stores the mapping information in the mapping database.

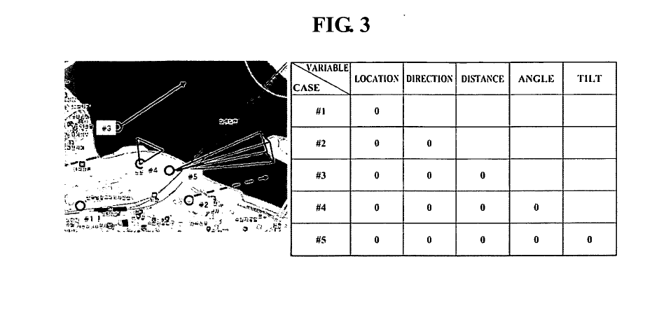

In exemplary embodiments, a mapping configuration varies with data included in the spatial information. Specifically, when the extracted spatial information includes only location information or when the extracted spatial information includes location information and direction information, the mapping configuration varies with the data included in the spatial information. It will be described in detail by referring to FIG. 3.

The spatial range query determination unit 124 determines whether a query is the spatial range query or a non-spatial range query. In this exemplary embodiments, the query is inputted in the user terminal 130. Specifically, the spatial range query determination unit 124 determines whether the query is a two/three dimensional spatial range query. In this exemplary embodiments, when the query is the two/three dimensional spatial range query, the spatial range query determination unit 124 outputs the information of the spatial range query to the spatial range processor 125.

The spatial range processor 125 receives the spatial range query from the spatial range query determination unit 124 and processes the spatial range query.

The spatial indexing unit 126 performs spatial indexing in order to retrieve the mapping information which is stored in the mapping database more quickly. In exemplary embodiments, the spatial indexing is performed by using a two dimensional index or three dimensional index. In exemplary embodiments, the spatial indexing unit 126 indexes the mapping information based on a rectangle tree (R-Tree) method or a k-dimensional tree (K-D Tree) method.

The map graphics generation unit 127 generates a map graphics based on a scale data of a map by using a map stored in the map database. In exemplary embodiments, the generated map graphics may be used when the spatial range query is selected in the user terminal 130.

The photo retrieval server 120 retrieves the mapping information of the spatial range query through the spatial indexing. In exemplary embodiments, the spatial range query is inputted from the user terminal 130. Also, the photo retrieval server 120 outputs the photo of the retrieved mapping information to the user terminal 130. The retrieval result output unit 128 outputs the photo of the mapping information received from the spatial range query determination unit 124 to the user terminal 130.

The user terminal 130 includes a display unit (display) 131, a photo retrieval processor 132, and a query generation unit (query generator) 133.

The query generation unit 133 generates the spatial range query in the map graphics which is generated in the map graphics generation unit 127. Specifically, a spatial range to be retrieved is selected in the query generation unit 133 by a user, from the map graphics. In exemplary embodiments, the spatial range may correspond to any one of a square, a cube, a circle, a sphere, and a free-shape which is generated by connecting locations designated by a user. However, a shape of the spatial range may not be limited.

The photo retrieval processor 132 outputs data of a photo retrieval spatial range to the photo retrieval server 120. Also, the photo retrieval processor 132 receives the photo included in the photo retrieval spatial range from the photo retrieval server 120, and outputs the photo to the display unit 131. In exemplary embodiments, the photo retrieval spatial range is selected by the user.

The display unit 131 displays the map graphics so that the user may select the spatial range. Also, the display unit 131 receives a retrieval result of the photo retrieval spatial range from the photo retrieval processor 132, and displays the retrieval result. In exemplary embodiments, the retrieval result includes the map graphics where the photo retrieval spatial range is displayed, and the photo included in the spatial range.

FIG. 3 is a diagram illustrating an example of mapping configuration based on spatial information of a photo.

Referring to FIG. 3, the mapping configuration is classified into five mapping configurations, based on spatial information of a photo.

First, when only source location information may be ascertained from the spatial information of the photo, the mapping configuration is composed of a point, as shown in case #1 of FIG. 3.

Second, when the source location information and source direction information, excluding distance information, may be ascertained from the spatial information of the photo, the mapping configuration is composed of a vector of the point and a dotted line, as shown in case #2 of FIG. 3. In exemplary embodiments, since the distance information may not be ascertained, a destination of the vector may not be ascertained. Accordingly, a distance is required to be set to a length of the vector by assuming the length to be a maximum distance which is available for photographing, for example, approximately 20 Km.

Third, when the source location information, the source direction information, and the distance information may be ascertained from the spatial information of the photo, the mapping configuration is composed of a vector of the point and a full line, as shown in case #3 of FIG. 3.

Fourth, when the source location information, the source direction information, the distance information, and pan angle information may be ascertained from the spatial information of the photo, the mapping configuration is composed of a photo range shape, for example, a triangle, as shown in case #4 of FIG. 3. In exemplary embodiments, the photo range shape is formed based on the point and an angle.

Fifth, when the location information, the direction information, the distance information, the pan angle information, and the tilt angle information may be ascertained from the spatial information of the photo, the mapping configuration is composed of the point and is shaped like a pyramid, as shown in case #5 of FIG. 3.

As described above, the mapping information of the map range of the spatial information are stored in the mapping database. In exemplary embodiments, in order to retrieve the mapping information of the spatial range which is desired by a user, from all the mapping information stored in the mapping database, overlapped ranges of all the mapping information and the spatial ranges which are queried by the user are required to be computed. Accordingly, data amount may be increased and a processing speed may decrease. Thus, according to an exemplary embodiment of the present invention, a method of spatial indexing is utilized for a fast retrieval.

Exemplary embodiments of a method of spatial indexing speed up a retrieval of an object on a map. Exemplary embodiments of spatial indexing perform indexing, considering the point, the line, and a location relationship of the object in a two/three dimensional spatial range. An R-Tree method and a K-D Tree method are used as a spatial indexing method in exemplary embodiments. However, other spatial indexing methods may be used as the spatial indexing method in the present invention. Hereinafter, the R-Tree method as the spatial indexing method will be described.

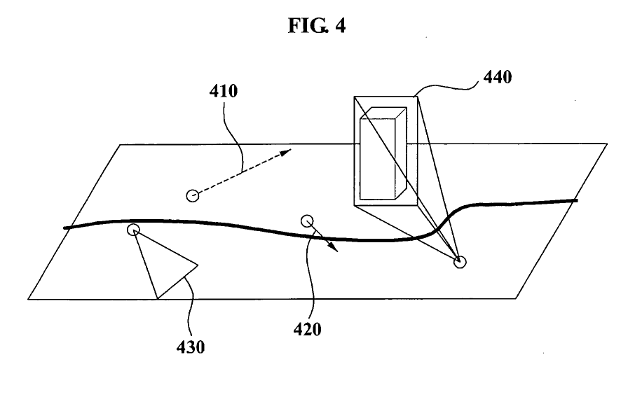

FIG. 4 is a diagram illustrating an example in which a map range mapping unit 123 illustrated in FIG. 2 maps spatial information on a three dimensional spatial range. FIG. 4 illustrates a mapping configuration according to spatial information illustrated in FIG. 3.

In FIG. 4, the mapping configurations according to spatial information of extracted photos are shown. In exemplary embodiments, as shown in FIG. 4, the mapping configurations includes the case #2 410, the case #3 420, the case #4 430, and the case #5 440 which are shown in FIG. 3. Specifically, each photo is mapped in a respective mapping configuration in a map range mapping unit 123 on a spatial range, according to extracted spatial information.

In order to speed up a photo retrieval, an R-Tree method is expanded into a three dimensional R-Tree method.

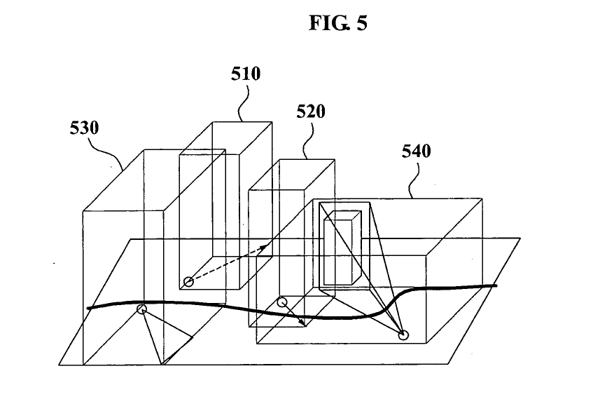

FIGS. 5 through 8 are diagrams illustrating the R-Tree method according to an exemplary embodiment of the present invention.

FIG. 5 is a diagram illustrating an example of a minimum bounding cube of each photo range by spatial indexing.

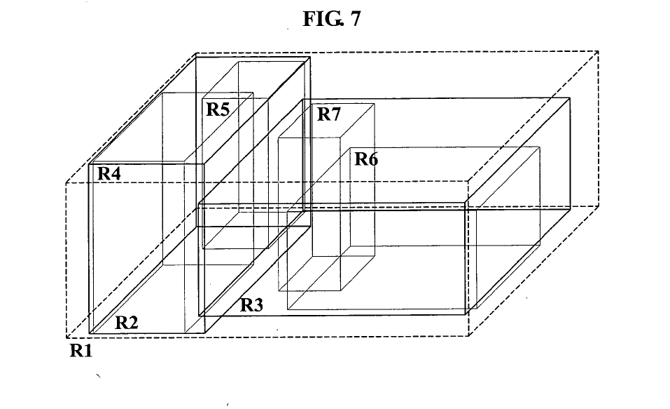

As shown in FIG. 5, mapped spatial information is expanded into a three dimensional cube by using the mapping information illustrated in FIG. 4. In exemplary embodiments, each of cube 510, 520, 530 and 540 is a minimum bounding cube including spatial information, respectively. Also, spatial indexing is performed to optimally reduce an overlapped portion, which will be described in detail in FIG. 7. In exemplary embodiments, the overlapped portion refers to an overlapped range of the mapping information and spatial range.

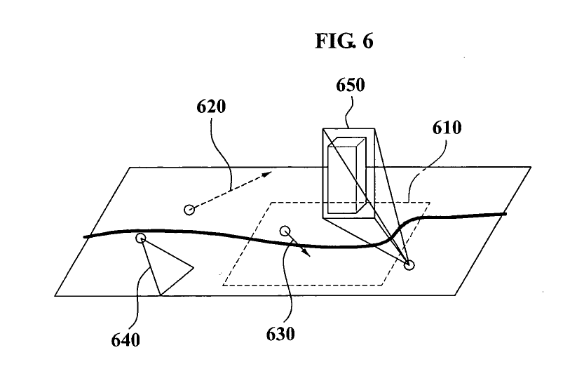

FIG. 6 is a diagram illustrating an example of a spatial range query in a dotted line.

Referring to FIG. 6, when a spatial range 610 to retrieve a photo is selected in a user terminal 130, a spatial range query is transferred to a photo retrieval server 120. Then, the photo retrieval server 120 determines the spatial range query, and transfers information of the photos 630 and 650 which is included in a corresponding spatial range to the user terminal 130.

A spatial indexing unit 126 of the photo retrieval server 120 indexes mapping information based on an R-Tree method, in order to speed up retrieving the photo of a spatial range query of FIG. 6. In exemplary embodiments, the mapping information is stored in the mapping database.

FIG. 7 is a diagram illustrating an example of three dimensional spatial indexing which is formed based on a minimum bounding cube.

The minimum bounding cube is formed including mapping information illustrated in FIG. 7. Also, spatial indexing of the mapping information is performed. In exemplary embodiments, each of the minimum bounding cubes is required to minimally overlap each other. Specifically, the spatial indexing of the mapping information is performed including a minimum bounding cube R1. In exemplary embodiments, the minimum bounding cube R1 includes a minimum bounding cube R2 and a minimum bounding cube R3. The minimum bounding cube R2 includes a minimum bounding cube R4 and a minimum bounding cube R5. The minimum bounding cube R3 includes a minimum bounding cube R6 and a minimum bounding cube R7. Also, the minimum bounding cube R2 and the minimum bounding cube R3 are formed to be minimally overlapped with each other.

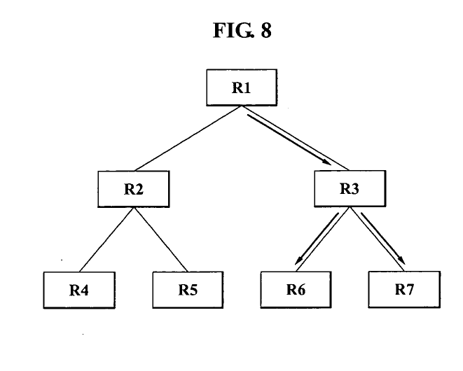

FIG. 8 is a diagram illustrating a retrieval process of an R-Tree method with respect to a spatial range query of FIG. 6. FIG. 8 illustrates a tree configuration which is formed by the R-Tree method.

Referring to FIG. 8, a photo of a spatial range query illustrated in FIG. 6 may be retrieved by using the tree configuration. Specifically, the spatial range 610 of FIG. 6 and the minimum bounding cube R1 are compared to each other, and it is determined whether the spatial range 610 and the minimum bounding cube R1 are overlapped. When the spatial range 610 and the minimum bounding cube R1 are overlapped, a minimum bounding cube R2 and a minimum bounding cube R3 are compared to the spatial range 610, respectively. In exemplary embodiments, since the spatial range 610 is not overlapped with the minimum bounding cube R2, other spatial ranges associated with the minimum bounding cube R2 are not retrieved. Also, since the spatial range 610 and the minimum bounding cube R3 overlap each other, other spatial ranges associated with the minimum bounding cube R3 are retrieved. Accordingly, it is ascertained that the spatial range 610 and the minimum bounding cube R6 overlap and, the spatial range 610 and the minimum bounding cube R7 overlap. Also, mapping information of the minimum bounding cube R6 and the minimum bounding cube R7 is obtained from the mapping database. Also, the photo corresponding to the mapping information is retrieved from the photo database, and transferred to the user terminal 130.

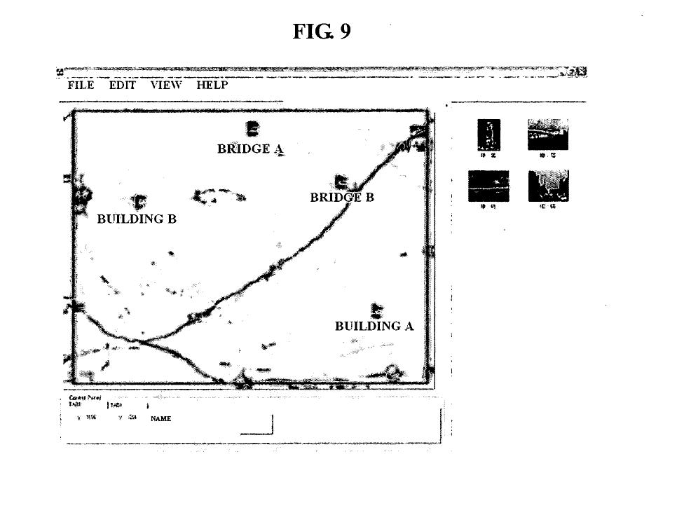

FIG. 9 is a diagram illustrating an example of a two dimensional range query and a retrieval result of the two dimensional range query according to an exemplary embodiment of the present invention.

As shown in FIG. 9, a map is a map graphics which is generated in the map graphics generating unit 127 of the photo retrieval server 120. A spatial range which is desired to be retrieved from the map graphics is selected by a user. Also, a photo corresponding to the spatial range is retrieved by using a spatial indexing method. Accordingly, photos included in the spatial range are retrieved and displayed on a right side of the map graphics. Various methods of selecting the spatial range, and methods of displaying the retrieved photos exist. As an example, the spatial range may be a spatial range query corresponding to any one of a square, a cube, a circle, a sphere, and a free-shape which is generated by connecting locations designated by a user. Also, the photos of the selected spatial range may be displayed on a top side or a bottom side of the map graphics.

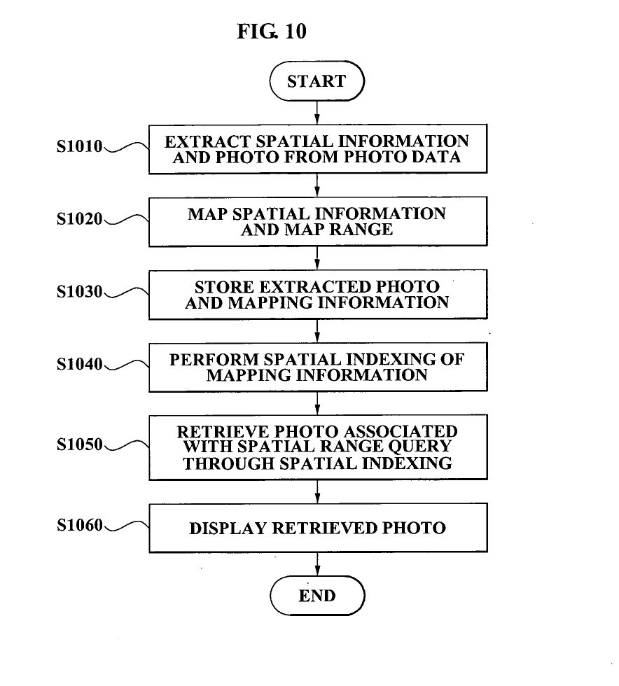

FIG. 10 is a flowchart illustrating a method of retrieving a photo based on spatial information according to an exemplary embodiment of the present invention.

A method of retrieving a photo based on spatial information according to an exemplary embodiment of the present invention includes operations S1010 through S1060. In operation S1010, spatial information and a photo is extracted from photo data. In operation S1020, the extracted spatial information and a map range are mapped. In exemplary embodiments, the map range corresponds to the spatial information. In operation S1030, the extracted photo and mapping information are stored. In operation S1040, spatial indexing of the mapping information is performed. In operation S1050, the photo associated with a spatial range query is retrieved through the spatial indexing. In operation S1060, the retrieved photo is displayed.

In exemplary embodiments, extracted spatial information may include at least one of location information, direction information, information about distance between a subject and a source location, pan angle information, and tilt angle information.

A method of retrieving a photo based on spatial information according to an exemplary embodiment of the present invention may include an operation of classifying a query into the spatial range query and a non-range query. Also, the photo associated with the spatial range query is retrieved through the spatial indexing, when the query is the spatial range query.

In exemplary embodiments, spatial indexing may be performed to index i the mapping information based on an R-Tree method.

In exemplary embodiments, spatial indexing may be performed to index the mapping information based on a K-D Tree method.

Referring to FIG. 10, in operation S1010, when the photo data is received from a device such as a digital camera, a method of retrieving a photo based on spatial information according to an exemplary embodiment of the present invention extracts the photo and the spatial information of the photo. The spatial information may be included in the photo data.

In operation S1020, a mapping configuration is determined based on the spatial information of the photo. Also, the extracted spatial information and the map range are mapped. In exemplary embodiments, the map range corresponds to the spatial information. In operation S1030, the extracted photo and the mapping information are stored.

In operation S1040, the spatial indexing of the mapping information is performed. In the present invention, the R-Tree method or the K-D Tree method are used as a spatial indexing method.

In operation S1050, when the spatial range query is inputted by a user, that is, a spatial range to be retrieved is selected by the user, the mapping information of the photo associated with the spatial range query is retrieved through the spatial indexing. Accordingly, the photo included in the spatial range is retrieved.

In operation S1060, the retrieved photo is displayed, along with the spatial range which is selected by the user, on a user terminal 130. In exemplary embodiments, when the user selects the photo displayed on the user terminal 130, the user may verify a content of the photo such as a shape of a subject or a time when the photo is taken.

In addition to the above-described exemplary embodiments, exemplary embodiments of the present invention can also be implemented by executing computer readable code/instructions in/on a medium/media, e.g., a computer readable medium/media. The medium/media can correspond to any medium/media permitting the storing and/or transmission of the computer readable code/instructions. The medium/media may also include, alone or in combination with the computer readable code/instructions, data files, data structures, and the like. Examples of code/instructions include both machine code, such as produced by a compiler, and files containing higher level code that may be executed by a computing device and the like using an interpreter.

The computer readable code/instructions can be recorded/transferred in/on a medium/media in a variety of ways, with examples of the medium/media including magnetic storage media (e.g., floppy disks, hard disks, magnetic tapes, etc.), optical media (e.g., CD-ROMs, or DVDs), magneto-optical media (e.g., floptical disks), hardware storage devices (e.g., read only memory media, random access memory media, flash memories, etc.) and storage/transmission media such as carrier waves transmitting signals, which may include computer readable code/instructions, data files, data structures, etc. Examples of storage/transmission media may include wired and/or wireless transmission media. For example, storage/transmission media may include optical wires/lines, waveguides, and metallic wires/lines, etc. including a carrier wave transmitting signals specifying instructions, data structures, data files, etc. The medium/media may also be a distributed network, so that the computer readable code/instructions are stored/transferred and executed in a distributed fashion. The medium/media may also be the Internet. The computer readable code/instructions may be executed by one or more processors. The computer readable code/instructions may also be executed and/or embodied in at least one application specific integrated circuit (ASIC) or Field Programmable Gate Array (FPGA).

In addition, hardware devices may be configured to act as one or more software modules in order to perform the operations of the above-described exemplary embodiments.

The term “module”, as used herein, denotes, but is not limited to, a software or hardware component, which performs certain tasks. A module may advantageously be configured to reside on the addressable storage medium/media and configured to execute on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules. In addition, the components and the modules can operate at least one processor (e.g. central processing unit (CPU)) provided in a device.

The computer readable code/instructions and computer readable medium/media may be those specially designed and constructed for the purposes of the present invention, or they may be of the kind well-known and available to those skilled in the art of computer hardware and/or computer software.

An apparatus, method, and medium for retrieving a photo based on spatial information according to the above-described embodiments of the present invention maps spatial information of a photo on a map range, performs spatial indexing of the mapping information, and thereby may accurately retrieve the photo included in a spatial range.

Also, an apparatus, method, and medium for retrieving a photo based on spatial information according to the above-described exemplary embodiments of the present invention retrieve a photo based on a spatial indexing method, and thereby may retrieve the photo more quickly.

Also, an apparatus, a method, and medium for retrieving a photo based on spatial information according to the above-described exemplary embodiments of the present invention may quickly retrieve a photo, and thereby may provide improved system performance and low power consumption.

Also, an apparatus, a method, and medium for retrieving a photo based on spatial information according to the above-described exemplary embodiments of the present invention may accurately retrieve a photo, and thereby may effectively manage photos.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An apparatus for retrieving a photo, comprising:
a spatial information extractor to extract spatial information and a photo from photo data;
a map range mapper to map the extracted spatial information and to map a map range corresponding to the spatial information;
a spatial range query processor to process a spatial range query;
a spatial indexer to perform spatial indexing of mapping information; and
a retrieval result output unit to retrieve the photo associated with the spatial range query through the spatial indexing, and outputting the retrieved photo.

2. The apparatus of claim 1, wherein the spatial information extractor extracts at least one of location information, direction information, information about a distance between a subject and a source location, pan angle information, and tilt angle information.

3. The apparatus of claim 1, further comprising:
a spatial range query determiner to classify a query into the spatial range query and a non-spatial range query.

4. The apparatus of claim 1, further comprising:
a photo database where the photo extracted by the spatial information extractor is stored;
a map database where map information is stored; and
a mapping database where the extracted spatial information and the mapping information of the map range corresponding to the spatial information is stored.

5. The apparatus of claim 1, wherein the spatial indexer indexes the mapping information based on a rectangle tree (R-Tree) method.

6. The apparatus of claim 1, wherein the spatial indexer indexes the mapping information based on a k-dimensional tree (K-D Tree) method.

7. The apparatus of claim 1, wherein the spatial range query processor processes a spatial range query corresponding to any one of a square, a cube, a circle, a sphere, and a free-shape which is generated by connecting locations designated by a user.

8. The apparatus of claim 1, further comprising:
a photo data generator to generate the photo data;
a query generator to generate the spatial range query; and
a display to display the retrieved photo.

9. A method of retrieving a photo, comprising:
extracting spatial information and a photo from photo data;
mapping the extracted spatial information and a map range corresponding to the spatial information;
storing the extracted photo and mapping information;
performing spatial indexing of the mapping information; and
retrieving the photo associated with a spatial range query through the spatial indexing.

10. The method of claim 9, wherein the extracted spatial information includes at least one of location information, direction information, information about a distance between a subject and a source location, pan angle information, and tilt angle information.

11. The method of claim 9, further comprising:
classifying a query into the spatial range query and a non-range query,
wherein the photo associated with the spatial range query is retrieved through the spatial indexing, when the query is the spatial range query.

12. The method of claim 11, further comprising:
displaying a spatial range and the retrieved photo.

13. The method of claim 9, wherein the performing spatial indexing indexes the mapping information based on an R-Tree method.

14. The method of claim 9, wherein the performing spatial indexing indexes the mapping information based on a K-D Tree method.

15. At least one computer readable medium storing instructions that control at least one processor to implement a method of retrieving a photo, the method comprising:
extracting spatial information and a photo from photo data;
mapping the extracted spatial information and a map range corresponding to the spatial information;
storing the extracted photo and mapping information;
performing spatial indexing of the mapping information; and
retrieving the photo associated with a spatial range query through the spatial indexing.
